(19) United States
(12) Patent Application Publication
(10) Pub. No.: US 2023/0203231 A1
(43) Pub. Date: Jun. 29, 2023

(54) USE OF EPOXY COMPOUNDS AS CARBON DIOXIDE SCAVENGERS IN PIR COMPRISING FOAMS FOR SUPERIOR THERMAL INSULATION PROPERTIES

(71) Applicant: Huntsman International LLC, The Woodlands, TX (US)

(72) Inventors: Thomas Julien JONCHERAY, Woluwe-Saint-Pierre (BE); Jan VANDENBROECK, Scherpenheuvel-Zichem (BE); Gilles Jean GEUMEZ, Waterloo (BE)

(21) Appl. No.: 17/928,558

(22) PCT Filed: Jun. 2, 2021
(86) PCT No.: PCT/EP2021/064750

§ 371 Date: Nov. 29, 2022

(30) Foreign Application Priority Data
Jun. 2, 2020 (EP) 20177774.5

(51) Int. Cl. C08G 18/08; C08G 18/09; C08G 18/18; C08G 18/22; C08G 18/16; C08G 18/42; C08J 9/14; C08J 9/00; C08K 5/1515

(52) U.S. Cl. CPC C08G 18/14; C08G 18/092; C08G 18/1875; C08G 18/225; C08G 18/163; C08G 18/4211; C08J 9/141; C08J 9/0023; C08K 5/1515; C08G 2101/00

(57) ABSTRACT

A reactive composition for making a PIR comprising foam at an isocyanate index of at least 120, said composition comprising at least an isocyanate composition comprising one or more isocyanate compounds, an isocyanate-reactive composition comprising one or more isocyanate-reactive compounds, at least one PIR promoting catalyst, at least one physical blowing agent with a lambda gas ≤12 mW/m·K at 10° C., at least one CO₂ scavenging compound selected from at least one epoxy compound, and optionally a catalyst promoting epoxy reaction with CO₂ characterized in that the amount of isocyanate-reactive compounds in the reactive composition is at least 10 wt % calculated on the total weight of the reactive composition, or at least more than the amount of epoxy compounds and the molar amount of epoxy compounds in the reactive composition is at least 7.8 times higher than the molar amount of CO₂ formed by the water present in the reactive composition after reaction with isocyanates.

### FIELD OF INVENTION

The present invention is related to polyisocyanurate (PIR) comprising insulation foams, more in particular semi-rigid and rigid PIR comprising insulation foams having significantly improved long term insulation values when used under diffusion tight conditions such that low thermal conductivity (lambda value) is achieved during the average economic lifetime of the foam.

Further the present invention is related to a reactive composition and a process for preparing PIR comprising insulation foams having significantly improved thermal insulation properties maintained over the average economic lifetime of the foam thereby making use of blowing agents having low lambda gas values (≤12 mW/m·K at 10° C.) in combination with a predetermined amount of CO₂ scavengers.

The invention is further related to the use of epoxy compounds as CO₂ scavengers in PIR comprising insulation foams.

### BACKGROUND

After fabrication, it is well known that closed cell rigid polyisocyanurate (PIR) and polyurethane (PUR) comprising insulation foams generally contain CO₂ which is released during foaming.

As the thermal conductivity (expressed in mW/m K and noted as “lambda” or “λ” value) of CO₂ gas is higher than the thermal conductivity of commonly used physical blowing agents, the total lambda value of a given PUR and PIR comprising foam is typically higher than if CO₂ gas was not present.

To solve that problem, the CO₂ could be removed from the cell gas mixture after foam production, for instance by the use of CO₂ scavengers incorporated within the foam.

A variety of CO₂ scavengers have been previously identified and successfully used for isocyanate-based foams (EP 1 031 601 and EP 0 618 253), such as for instance zeolites, calcium hydroxide, sodium hydroxide, lithium hydroxide, . . .

WO2019/211259 discloses the use of NaOH and KOH compounds as CO₂ scavengers. Due to their low cost (commodity chemicals) and their quantitative reaction with CO₂ these compounds result in efficient scavenging. Nevertheless, they are used in the form of solid particles which is not ideal in terms of processing. Moreover, they are only applicable to ageing conditions in which some moisture diffusion inside the foams can take place (i.e. moisture-catalyzed scavenging), which then excludes their use in applications such as Composite Panels, Appliances or Pipes, unless specific moisture permeable facers are used.

EP0723989 discloses the use of epoxy compounds as CO₂ scavengers in a method for manufacturing a polyurethane (PUR) thermal insulating foamed material wherein the amount of epoxy compounds should be not less than 2.5 molar equivalents and not more than 4 molar equivalents to the stoichiometric moles of carbon dioxide produced from water used as the reactive blowing agent. However, EP0723989 is limited to polyurethane insulation foams and (predominantly) PIR comprising insulation foams are not disclosed.

On the other hand, the criteria for thermal insulation foams, especially for use in construction and consumer goods, become more and more stringent and there is a need to further improve (i.e. reduce) the lambda value (thermal conductivity) of predominantly PIR comprising foams and to maintain the low lambda value over the whole life time of the foam.

To further improve the lambda value of PIR comprising foams, alternative blowing agents with very low thermal conductivity were implemented such as Hydro Fluoro Carbons (HFCs). Very recently Hydro Fluoro Olefins (HFOs) and Hydro Chloro Fluoro Olefins (HCFOs) were also implemented.

It is however a challenge to both achieve the removal of CO₂ gas in a (predominantly) PIR comprising insulation foam and at the same time improve the lambda value significantly thereby avoiding an overdose and/or negative impact of a residual amount of scavenger and to obtain predominantly PIR comprising foams which have very low thermal conductivity which also remains low over long time periods (at least during the average economic lifetime of the foam).

### GOAL OF THE INVENTION

It is the goal of the invention to improve the thermal insulation of polyisocyanurate (PIR) comprising insulation foams made using an isocyanate index >120 significantly and to maintain the superior thermal insulation properties (i.e. the low lambda values) over long time periods.

The goal of the invention is achieved by capturing the CO₂ released during foaming and during ageing, in combination with the use and presence of blowing agents having low thermal conductivity.

Therefore, the present invention relates to novel polyisocyanurate (PIR) comprising insulation foams having significantly improved insulation values maintained over the average economic lifetime of the foam as well as a novel reactive mixture and processing method to fabricate said improved insulation foams and use of the improved insulation foams for thermal insulation.

### SUMMARY OF THE INVENTION

A reactive composition for making a PIR comprising foam at an isocyanate index of at least 120 is disclosed wherein said foam is having significantly improved insulation values maintained over the average economic lifetime of the foam. Said reactive composition comprising at least:
a) An isocyanate composition comprising one or more isocyanate compounds, and
b) An isocyanate-reactive composition comprising one or more isocyanate-reactive compounds, and
c) At least one PIR promoting catalyst, and
d) At least one physical blowing agent with a lambda gas ≤12 mW/m·K at 10° C., and
e) At least one CO₂ scavenging compound selected from at least one epoxy compound having an equivalent weight lower than 300 g/mol, and
f) Optionally a catalyst promoting epoxy reaction with CO₂
Characterized in that the amount of isocyanate-reactive compounds b) in the reactive composition is at least 10 wt % calculated on the total weight of the reactive composition, or at least more than the amount of epoxy compounds and the molar amount of epoxy compounds in the reactive composition is at least 7.8 times higher than the molar amount of CO₂ formed by the water present in the reactive composition after reaction with isocyanates.

According to embodiments, the amount of isocyanate-reactive compounds b) in the reactive composition is at least 10 wt %, preferably at least 15 wt %, more preferably at least 20 wt % calculated on the total weight of the reactive composition.

According to embodiments, the molar amount of epoxy compounds in the reactive composition is preferably at least 10 times, more preferably at least 15 times higher than the molar amount of CO₂ formed by the water present in the reactive composition after reaction with isocyanates. The ratio of the molar amounts of epoxy compounds in the reactive composition over the molar amount of CO₂ formed by the water is also referred to in this application as the molar ratio of epoxy groups over water in the reactive composition.

According to embodiments, the maximum amount of all epoxy compounds in the reactive composition is <25 wt %, preferably <20 wt % calculated on the total weight of the reactive composition.

According to embodiments, the at least one epoxy compound in the reactive composition is selected from epoxy compounds having equivalent weight lower than 300 g/mol, preferably lower than 250 g/mol, more preferably lower than 200 g/mol and wherein the at least one epoxy compound used is liquid at 20° C.

According to embodiments, the catalyst used for promoting epoxy reaction with CO₂ is selected from ammonium salts, more preferably selected from tetrabutylammonium bromide and/or tetrabutylammonium iodide.

According to embodiments, the at least one physical blowing agent having a lambda gas value ≤12 mW/m·K@10° C. is selected from an HFO blowing agent and/or HCFO blowing agent and/or hydrocarbon blowing agent such as cyclopentane and mixtures thereof.

According to embodiments, the at least one physical blowing agent having a lambda gas value ≤12 mW/m·K@10° C. is selected from chlorofluorocarbons (CFCs) and/or hydrofluorocarbons (HFCs) and/or hydrochlorofluorocarbons (HCFCs).

According to embodiments, the polyisocyanate compounds in the reactive composition are selected from a toluene diisocyanate, a methylene diphenyl diisocyanate or a polyisocyanate composition comprising a methylene diphenyl diisocyanate or a mixture of such polyisocyanates.

According to embodiments, the one or more isocyanate reactive compounds in the reactive composition comprise polyols and polyol mixtures having average hydroxyl numbers of from 50 to 1000, especially from 150 to 700 mg KOH/g, and hydroxyl functionalities of from 2 to 8, especially from 3 to 8.

According to embodiments, the blowing agent is present in the reactive composition in an amount of 1 to 60 parts by weight, preferably from 2 to 45 parts by weight per hundred parts by weight isocyanate reactive compounds.

According to embodiments, the reactive composition is further comprising beside the blowing agents having a lambda gas value ≤12 mW/m·K at 10° C. additional blowing agents having a lambda gas value >12 mW/m·K at 10° C. and wherein the ratio of blowing agents having a lambda gas value ≤12 mW/m·K at 10° C. to the additional blowing agents is in the weight ratio 95/5 up to 5/95 calculated on the total weight of all blowing agents.

Further, the invention discloses a process for making a PIR comprising insulation foam having significantly improved insulation values maintained over the average economic lifetime of the foam, said process comprising combining and/or mixing the ingredients of the reactive composition at an isocyanate index of at least 120, preferably at least 150, more preferably at least 200, most preferably at least 250.

According to embodiments, the process for making a PIR comprising insulation foam of the invention is further including a step of sealing the foam with a gas diffusion tight sealing wherein at least 50%, preferably at least 90%, more preferably 95%, most preferably 90-100% of the foam surfaces are covered with the gas diffusion tight sealing.

According to embodiments, the gas diffusion tight sealing in the PIR comprising insulation foam of the invention is selected from metal foils such as Aluminum foil or metal multilayers comprising Aluminum foil and/or gas barrier polymer layers such as ethylene vinyl alcohol copolymer (EVOH), polyvinyl alcohol (PVOH) and its copolymers, polyvinylidene chloride (PVDC), polyamide (PA), polyethylene terephthalate (PET), Polyketones (PK), Polyacrilonitriles (PAN) and combinations thereof and/or a thermoplastic polymer such as polyethylene and/or polypropylene.

According to embodiments, the process for making a PIR comprising insulation foam of the invention is further including after sealing the foam a step of ageing the foam, said ageing step includes keeping the foam at a given temperature above room temperature until a stable low lambda value is obtained, preferably at a temperature between 25 and 100° C., more preferably between 40 and 80° C., even more preferably between 55 and 70° C. for less than one month, more preferably for less than one week, even more preferably for less than one day.

Further, the invention discloses a stabilized PIR comprising insulation foam made using the process according to the invention wherein the wt % of CO₂ in the stabilized aged foam is between 0 and 2 wt %, preferably between 0 and 1 wt %, more preferably between 0 and 0.5 wt %, calculated on the total weight of the stabilized aged foam.

According to embodiments, the stabilized PIR comprising insulation foam according to the invention is having a foam density <45 kg/m³ and a stabilized thermal conductivity <20 mW/m·K at 10° C., preferably 14 up to 20 mW/m·K at 10° C.

According to embodiments, the stabilized PIR comprising insulation foam according to the invention is having a foam density >45 kg/m³ and a stabilized thermal conductivity <25 mW/m·K at 10° C., preferably 14 up to 25 mW/m·K at 10° C.

The stabilized PIR comprising insulation foam according to the invention is suitable for use as thermal insulator such as construction thermal insulation foam, appliance thermal insulation foam or pipe insulation.

The independent and dependent claims set out particular and preferred features of the invention. Features from the dependent claims may be combined with features of the independent or other dependent claims as appropriate.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention.

### Definitions and Terms

In the context of the present invention the following terms have the following meaning:
1) The expression “isocyanate index” or “NCO index” or “index” as used herein refers to the ratio of NCO-groups over isocyanate-reactive hydrogen atoms present in a formulation, given as a percentage:

$$\frac{[ NCO ] \times 100 ( \% )}{[ active hydrogen ]} .$$

In other words the NCO-index expresses the percentage of isocyanate actually used in a formulation with respect to the amount of isocyanate theoretically required for reacting with the amount of isocyanate-reactive hydrogen used in a formulation.
It should be observed that the isocyanate index as used herein is considered from the point of view of the actual polymerisation process preparing the material involving the isocyanate ingredient and the isocyanate-reactive ingredients. Any isocyanate groups consumed in a preliminary step to produce modified polyisocyanates (including such isocyanate-derivatives referred to in the art as prepolymers) or any active hydrogens consumed in a preliminary step (e.g. reacted with isocyanate to produce modified polyols or polyamines) are not taken into account in the calculation of the isocyanate index. Only the free isocyanate groups and the free isocyanate-reactive hydrogens (including those of water, if used) present at the actual polymerisation stage are taken into account.
It is possible that part of the epoxy compounds used as CO₂ scavenger react to some extent as well with isocyanates to form in-situ during foaming oxazolidone/oxazolidinone groups, but these reactions are not considered for the index calculation herein.
2) The expression “isocyanate-reactive compounds” (also referred to as iso-reactive compounds) and “isocyanate-reactive hydrogen atoms” as used herein for the purpose of calculating the isocyanate index refers to the total of active hydrogen atoms in hydroxyl and amine groups present in the isocyanate reactive compounds; this means that for the purpose of calculating the isocyanate index at the actual polymerisation process one hydroxyl group is considered to comprise one reactive hydrogen, one primary amine group is considered to comprise one reactive hydrogen and one water molecule is considered to comprise two active hydrogens.
3) “Reactive composition” or “Reaction mixture” as used herein refers to a combination of compounds wherein the polyisocyanates are kept in one or more containers separate from the isocyanate-reactive components.
4) The term “average nominal functionality” (or in short “functionality”) is used herein to indicate the number average functionality. For example, the average nominal hydroxyl functionality of a polyol or polyol composition indicates the number average of hydroxyl groups per molecule of the polyol or polyol composition on the assumption that this is the number average functionality (number of active hydrogen atoms per molecule) of the initiator(s) used in their preparation although in practice it will often be somewhat less because of some terminal unsaturation. The average nominal epoxy functionality of epoxy compounds or epoxy composition indicates the number average of epoxy groups per molecule of the epoxy compound or epoxy composition.
5) The word “average” refers to number average unless indicated otherwise.
6) The term “equivalent molecular weight” of a compound refers to the molecular weight of a compound divided by its functionality.
7) “Trimerization catalyst” as used herein refers to a catalyst being able to catalyse (promote) the formation of isocyanurate groups from polyisocyanates. This means that isocyanates can react with one another to form macromolecules with isocyanurate structures (polyisocyanurate=PIR). Reactions between isocyanates-polyols and isocyanates-isocyanates (homopolymerization) can take place simultaneously or in direct succession, forming macromolecules with urethane and isocyanurate structures.
8) “Polyisocyanurate comprising foam”, “PIR comprising foam” and “predominantly PIR comprising insulation foam” as used herein refers to a foam made at an isocyanate index of at least 120, more preferably at an isocyanate index higher than 180, most preferably at an isocyanate index higher than 250 and comprising predominantly polyisocyanurate (PIR) compounds.
9) “Foam density” as used herein refers to the density measured on foam samples according to ISO 845 and is calculated as weight/volume and is expressed in kg/m³.
10) “Thermal conductivity” measurements are carried out at 10° C. according to ISO8301 using a Heat Flow Meter (HFM) apparatus. “Lambda value”, “X, value” or “k value” as used herein refers to the thermal conductivity of a material normally expressed in mW/m·K. The lower the lambda value the better the thermal insulation performance.
11) “Closed cell content” of a foam is measured using a pycnometer according to ISO 4590.
12) “Stabilized lambda value”, “Stabilized λ value” and “Stabilized k value” of a foam as used herein refers to a thermal conductivity value at 10° C. (according to ISO8301) which is not changing over time (variations ≤0.5 mW/m·K). For foams according to the invention, a stabilized lambda value is achieved after the time required to capture the CO₂ by the CO₂ scavenging compound according to the invention (after completion of the CO₂ scavenging process). The completion of the CO₂ scavenging process can take hours up to several months depending on the type of formulations.
13) “Ageing” refers to a treatment of a foam wherein the foam is being kept at a certain temperature for a given amount of time.
14) The expression “molar amount of epoxy compounds in the reactive composition over the molar amount of CO₂ formed by the water present in the reactive composition after reaction with isocyanates” is also referred to in this application as “the molar ratio of epoxy groups over water” present in the reactive composition. At an isocyanate index >120 it is assumed that all water present in the reactive composition is converted to CO₂ by means of reaction of the water with free NCO groups.

### DETAILED DESCRIPTION

The present invention will be described with respect to particular embodiments. It is to be noticed that the term “comprising”, used in the claims, should not be interpreted as being restricted to the means listed thereafter; it does not exclude other elements or steps. It is thus to be interpreted as specifying the presence of the stated features, steps or components as referred to, but does not preclude the presence or addition of one or more other features, steps or components, or groups thereof. Thus, the scope of the expression “a device comprising means A and B” should not be limited to devices consisting only of components A and B. It means that with respect to the present invention, the only relevant components of the device are A and B.

Throughout this specification, reference to “one embodiment” or “an embodiment” are made. Such references indicate that a particular feature, described in relation to the embodiment is included in at least one embodiment of the present invention. Thus, appearances of the phrases “in one embodiment” or “in an embodiment” in various places throughout this specification are not necessarily all referring to the same embodiment, though they could. Furthermore, the particular features or characteristics may be combined in any suitable manner in one or more embodiments, as would be apparent to one of ordinary skill in the art.

It is to be understood that although preferred embodiments and/or materials have been discussed for providing embodiments according to the present invention, various modifications or changes may be made without departing from the scope and spirit of this invention.

The present invention relates to polyisocyanurate (PIR) comprising insulation foams suffering from deteriorated insulation values due to the formation of CO₂.

The present invention developed a method in which an optimized amount of CO₂ scavenger compound is added to the reactive compositions used to make PIR comprising foams which captures most of the CO₂ formed during foaming and ageing in combination with the use of blowing agents with lambda ≤12mW/m.k at 10° C.

The present invention therefore relates to novel polyisocyanurate (PIR) comprising insulation foams having significantly improved thermal insulation values maintained over the average economic lifetime of the foam, a novel processing method to fabricate said improved thermal insulation foams and use of the improved insulation foams for thermal insulation.

According to a first aspect, a reactive composition for making a polyisocyanurate (PIR) comprising insulation foam having significantly improved thermal insulation properties maintained over the average economic lifetime of the foam is disclosed.

The reactive composition used to make the PIR comprising foam of the invention at an isocyanate index of at least 120 is comprising:
a) An isocyanate composition comprising one or more isocyanate compounds,
b) An isocyanate-reactive composition comprising one or more isocyanate-reactive compounds, and
c) At least one PIR promoting catalyst, and
d) At least one physical blowing agent with a lambda gas ≤12 mW/m·K at 10° C., and
e) At least one CO₂ scavenging compound selected from at least one epoxy compound having an equivalent weight lower than 300 g/mol, and
f) Optionally a catalyst promoting epoxy reaction with CO₂
Characterized in that the amount of isocyanate-reactive compounds b) in the reactive composition is at least 10 wt % calculated on the total weight of the reactive composition, or at least more than the amount of epoxy compounds and the molar amount of epoxy groups in the reactive composition is at least 7.8 times higher than the molar amount of CO₂ formed by the water present in the reactive composition after reaction with isocyanates.

According to embodiments, the amount of isocyanate-reactive compounds b) in the reactive composition is at least 10 wt %, preferably at least 15 wt %, more preferably at least 20 wt % calculated on the total weight of the reactive composition.

According to embodiments, the molar amount of epoxy groups in the reactive composition is preferably at least 10 times, more preferably at least 15 times higher than the molar amount of CO₂ formed by the water present in the reactive composition after reaction with isocyanates.

According to embodiments, the total amount of epoxy compounds in the reactive composition should be at least a few weight percent, preferably >2 wt %, more preferably >5wt %, most preferably >10 wt % calculated on the total weight of the reactive composition independently of the amount of water present in the reactive composition in order to be able to scavenge the CO₂ formed from carbodiimide reaction and/or additional CO₂ formed by the reaction between residual NCOs and moisture.

According to embodiments, the maximum amount of all epoxy compounds in the reactive composition should be <25 wt %, preferably <20 wt % calculated on the total weight of the reactive composition to avoid issues such as excessive reaction with isocyanate, increased exotherm, dimensional stability issues, too much unreacted epoxy compounds, . . .

According to embodiments, the at least one epoxy compound is selected from epoxy compounds having equivalent weight lower than 300 g/mol, preferably lower than 250 g/mol, more preferably lower than 200 g/mol. Using epoxy compound with low equivalent weight is advantageous to ensure using as little as possible epoxy compound (in wt % of the total formulation) for optimum CO₂ scavenging.

According to embodiments, the epoxy compound(s) used is/are liquid at 20° C.

Examples of suitable (poly)epoxy compounds are:

1) Polyglycidyl and poly(β-methylglycidyl) esters, obtainable by reacting a compound having at least one carboxyl groups in the molecule and, respectively, epichlorohydrin and β-methylepichlorohydrin. The reaction is expediently carried out in the presence of bases. Aliphatic mono and poly carboxylic acids can be used as the compound having at least one carboxyl group in the molecule. Examples of such mono carboxylic acids are propionic acid, butyric acid and pentanoic acid. Examples of such polycarboxylic acids are oxalic acid, succinic acid, glutaric acid, adipic acid, pimelic acid, suberic acid and azelaic acid. However, cycloaliphatic polycarboxylic acids, such as, for example, tetrahydrophthalic acid, 4-methyltetrahydrophthalic acid, hexahydrophthalic acid or 4-methylhexa-hydrophthalic acid, may also be used. Furthermore, aromatic polycarboxylic acids, such as, for example, phthalic acid, isophthalic acid or terephthalic acid, may be used.

2) Polyglycidyl or poly(β-methylglycidyl) ethers, obtainable by reacting a compound having at least one free alcoholic hydroxyl groups and/or phenolic hydroxyl groups with epichlorohydrin or β-methylepichlorohydrin under alkaline conditions or in the presence of an acidic catalyst with subsequent treatment with alkali. The glycidyl ethers of this type are derived, for example, from acyclic alcohols, for example from butanol, pentanol, ethylene glycol, diethylene glycol or higher poly(oxyethylene) glycols, propane-1,2-diol or poly(oxypropylene) glycol s, propane-1,3-diol, butane-1,4-diol, poly(oxytetramethylene) glycols, pentane-1,5-diol, hexane-1,6-diol, hexane-2,4,6-triol, glycerol, 1,1,1-trimethylolpropane, pentaerythritol or sorbitol, and from polyepichlorohydrins. Further glycidyl ethers of this type are derived from cycloaliphatic alcohols, such as 1,4-cyclohexanedimethanol, bis(4-hydroxycyclohexyl)methane or 2,2-bis(4-hydroxycyclohexyl)propane, or from alcohols which contain aromatic groups and/or further functional groups, such as N,N-bis(2-hydroxyethyl)aniline or p,p′-bis(2-hydroxyethylamino)-diphenylmethane. The glycidyl ethers may also be based on mononuclear phenols, such as, for example, phenol, p tert-butylphenol, resorcinol or hydroquinone, or on polynuclear phenols, such as, for example, bis(4-hydroxyphenyl)methane, 4,4′-dihydroxybiphenyl, bis(4-hydroxyphenyl)sulphone, 1,1,2,2-tetrakis(4-hydroxyphenyl)ethane, 2,2-bis(4-hydroxyphenyl)propane or 2,2-bis(3,5-dibromo-4-hydroxyphenyl)propane. Further suitable hydroxy compounds for the preparation of glycidyl ethers are novolacs, obtainable by condensation of aldehydes, such as formaldehyde, acetaldehyde, chloral or furfuraldehyde, with phenols or bisphenols which are unsubstituted or substituted by chlorine atoms or C1-C9-alkyl groups, such as, for example, phenol, 4-chlorophenol, 2-methylphenol or 4-tert-butylphenol.

3) Poly(N-glycidyl) compounds, obtainable by dehydrochlorination of the reaction products of epichlorohydrin with amines which contain at least one amine hydrogen atom. These amines are, for example, aniline, n-butylamine, bis(4-aminophenyl)methane, m-xylylenediamine or bis(4-methylaminophenyl)methane. The poly(N-glycidyl) compounds also include triglycidyl isocyanurate, N,N′ -diglycidyl derivatives of cycloalkyleneureas, such as ethyleneurea or 1,3-propyleneurea, and diglycidyl derivatives of hydantoins, such as of 5,5-dimethylhydantoin.

4) Poly(S-glycidyl) compounds, for example S-glycidyl derivatives, which are derived from thiols, such as, for example, ethane-1,2-dithiol or bi s(4-mercaptomethylphenyl) ether.

5) Cycloaliphatic epoxy compound(s), such as, for example, bis(2,3-epoxycyclopentyl)ether, 2,3-epoxycyclopentylglycidyl ether, 1,2-bis(2,3-epoxycyclopentyloxy)ethane or 3,4-epoxycyclohexylmethyl-3′,4′-epoxycyclohexanecarboxylate.

It is also possible to use (poly)epoxy compound(s) in which the 1,2-epoxy groups are bonded to different hetero atoms or functional groups; these compounds include, for example, the N,N,O-triglycidyl derivative of 4-aminophenol, the glycidyl ether-glycidyl ester of salicylic acid, N-glycidyl-N′-(2-glycidyloxypropyl)-5,5-dimethylhydantoin or 2-glycidyloxy-1,3-bis(5,5-dimethyl-1-glycidylhydantoin-3-yl)propane.

Particularly preferred are those (poly)epoxy compound(s) mentioned in 1) and 2) and most preferred are those mentioned in 2).

Commercially available suitable epoxy compounds include phenyl glycidyl ether, butanediol diglycidyl ether (available from Huntsman as Araldite® DY-D) and bisphenol A diglycidyl ether (available from Huntsman as Araldite® GY240).

According to embodiments, the catalyst used for promoting epoxy reaction with CO₂ may be selected from ammonium salts represented by tetrabutylammonium bromide, tetrabutylammonium iodide or the like. Other preferred onium salts are a phosphonium salt represented by tetraphenyl phosphonium bromide, triphenylmethyl phosphonium bromide, and a sulfonium salt represented by tributylsulfonium bromide. For example a complex compound of an iodofluorohydrocarbon with a non-conjugated amine, ammonium salt, or a quaternary ammonium salt can be used. Metal halides and alkali metal halides can also be used, alone or in combination with other catalysts. Examples of metal halides include zinc chloride, zinc bromide and zinc iodide. Examples of alkali metal halides include lithium chloride, lithium bromide, lithium iodide and sodium iodide. By using a catalyst promoting epoxy reaction with CO₂ the carbon dioxide will chemically react faster with epoxy groups of the epoxy compound to form a solid or liquid cyclic carbonate.

According to preferred embodiments, the blowing agents in the reactive composition are selected from at least HFO blowing agents and/or HCFO blowing agents and/or hydrocarbons such as cyclo-pentane having a lambda gas value ≤12 mW/m·K at 10° C.

According to preferred embodiments, the blowing agents comprise at least HFO blowing agents and/or HCFO blowing agents and/or hydrocarbon such as cyclo-pentane having a a lambda gas value ≤12 mW/m·K at 10° C.

According to embodiments, the blowing agents in the reactive composition comprise at least 3,3,3-trifluoropropene, 1,2,3,3,3 -pentafluoropropene, cis- and/or trans-1,3,3,3-tetrafluoropropene and/or 2,3,3,3-tetrafluoropropene, and/or 1,1,1,4,4,4-hexafluorobut-2-ene, and/or 1-chloro-3,3,3-trifluoropropene, and/or 2-chloro-3,3,3-trifluoropropene and mixtures thereof.

Preferred examples of commercially available suitable HFO blowing gases are Honeywell HFO-1234ze (Honeywell's trade name for trans-1,3,3,3-tetrafluoropropene) or Opteon® 1100 (Chemours' trade name for cis-1,1,1,4,4,4-hexafluorobut-2-ene, CF₃CH═CHCF₃).

A preferred example of a commercially available suitable HCFO blowing gas is Honeywell Solstice® LBA 1233zd (Honeywell's trade name for trans-1-chloro-3,3,3-trifluoropropene, CHCl═CHCF₃) or Forane® 1233zd (Arkema's trade name for trans-1-chloro-3,3,3-trifluoropropene, CHCl═CHCF₃).

According to embodiments, the reactive composition may comprise blowing agents having a lambda gas value ≤12 mW/m·K at 10° C. selected from hydrofluorocarbons (HFCs) and/or hydrocarbons such as cyclo-pentane and mixtures thereof.

According to embodiments, the reactive composition may further comprise blowing agents such as hydrocarbons selected from iso-pentane, iso-butane, n-pentane and mixtures thereof having a lambda gas value >12 mW/m·K at 10° C.

According to embodiments, the reactive composition may further comprise additional blowing agents selected from formic acid, methylformate, dimethyl ether, water, methylene chloride, acetone, t-butanol, argon, krypton, xenon and mixtures thereof.

According to embodiments, the reactive composition may further comprise (optionally) one or more surfactants, one or more flame retardants, one or more antioxidants, one or more auxiliary blowing agents, one or more auxiliary urethane catalysts, one or more auxiliary trimerisation catalysts, or combinations thereof.

According to a second aspect, a process for making a polyisocyanurate (PIR) comprising insulation foam having significantly improved thermal insulation properties maintained over the average economic lifetime of the foam is disclosed thereby making use of the reactive composition of the first aspect of the invention.

The process for making the polyisocyanurate (PIR) comprising insulation foam according to the invention may comprise combining and/or mixing at least following compounds to form a reactive composition at an isocyanate index of at least 120:
a) An isocyanate composition comprising one or more isocyanate compound,
b) An isocyanate-reactive composition comprising one or more isocyanate-reactive compound, and
c) At least one PIR promoting catalyst, and
d) At least one physical blowing agent with a lambda gas ≤12 mW/m·K at 10° C., and
e) At least one CO₂ scavenging compound selected from at least one epoxy compound having an equivalent weight lower than 300 g/mol, and
f) Optionally a catalyst promoting epoxy reaction with CO₂
Characterized in that the amount of isocyanate-reactive compounds b) in the reactive composition is at least 10 wt % calculated on the total weight of the reactive composition, or at least more than the amount of epoxy compounds and the molar amount of epoxy groups in the reactive composition is at least 7.8 times higher than the molar amount of CO₂ formed by the water present in the reactive composition after reaction with isocyanates.

According to the invention an optimized amount of CO₂ scavenger compound needs to be added to the formulations used to make the PIR comprising insulation foam of the invention, wherein said optimized amount of CO₂ scavenger compound captures the CO₂ formed during foaming and ageing and which minimizes the amount of residual unreacted CO₂ scavenger compound.

According to embodiments, the amount of isocyanate-reactive compounds b) in the reactive composition is at least 10 wt %, preferably at least 15 wt %, more preferably at least 20 wt % calculated on the total weight of the reactive composition.

According to embodiments, the molar amount of epoxy groups in the reactive composition is preferably at least 10 times, more preferably at least 15 times higher than the molar amount of CO₂ formed by the water present in the reactive composition after reaction with isocyanates.

According to embodiments, the total amount of epoxy compounds in the reactive composition should be at least a few weight percent, preferably >2 wt %, more preferably >5wt % , most preferably >10 wt % calculated on the total weight of the reactive composition independently of the amount of water present in the reactive composition in order to be able to scavenge the CO₂ formed from carbodiimide reaction and/or additional CO₂ formed by the reaction between residual NCOs and moisture.

According to embodiments, the maximum amount of all epoxy compounds in the reactive composition should be <25 wt %, preferably <20 wt % calculated on the total weight of the reactive composition to avoid issues such as excessive reaction with isocyanate, increased exotherm, dimensional stability issues, too much unreacted epoxy compounds, . . .

According to embodiments, process for making the polyisocyanurate (PIR) comprising insulation foam according to the invention may further comprise combining and mixing one or more surfactants, one or more additives such as nucleating agents, adhesion promoters, one or more flame retardants, water, one or more antioxidants, one or more auxiliary blowing agents, one or more auxiliary urethane catalysts, one or more auxiliary trimerisation catalysts, one or more blowing catalysts or combinations thereof;

According to embodiments, the process for making the polyisocyanurate (PIR) comprising insulation foam according to the invention is performed at an isocyanate index of at least 120, preferably at least 150, more preferably at an isocyanate index higher than 200, most preferably at an isocyanate index higher than 250.

According to embodiments, the PIR promoting catalyst compound is selected from at least a trimerisation catalyst compound. Any compound that catalyzes the isocyanate trimerisation reaction can be used as trimerisation catalyst compound, such as tertiary amines, triazines, and, most preferably, metal salt trimerisation catalysts. Two or more different metal salt trimerisation catalysts can be used in the process of the present invention.

According to embodiments, the trimerization catalyst compound is a metal salt trimerisation catalyst selected from one or more organic salts, preferably said organic salt is selected from alkali metal, earth alkali metal and/or quaternary ammonium organic salts, more preferably from carboxylates and/or alkoxides such as potassium acetate, potassium hexanoate, potassium ethylhexanoate, potassium octanoate, potassium octoate, potassium lactate, sodium ethoxide, sodium formate, potassium formate, sodium acetate, potassium benzoate and mixtures thereof. Preferred metal salt trimerisation catalysts are potassium acetate such as commercially available Polycat® 46 catalyst from Air Products, Catalyst LB from Huntsman and Dabco® K15 catalyst from Air Products.

According to embodiments, the trimerization catalyst compound is a metal salt trimerization catalyst selected from a Lithium halide salt, preferably LiCl compounds. Said Lithium halide (LiCl) compounds forming an active trimerization catalyst once combined with the epoxy compound(s).

According to embodiments, the trimerization catalyst compound is a metal salt trimerization catalyst selected from potassium ethoxide, sodium ethoxide, potassium methoxide, sodium methoxide, potassium tert-butoxide, titanium isopropoxide and mixtures thereof dissolved in a suitable carrier such as a monool/polyol composition.

According to preferred embodiments, the process for making the polyisocyanurate (PIR) comprising insulation foam according to the invention further includes the step of sealing the foam with a gas diffusion tight sealing wherein at least 50%, at least 75%, preferably at least 90%, more preferably 95%, most preferably 90-100% of the foam surfaces are covered with the gas diffusion tight sealing.

According to embodiments, the gas diffusion tight sealing is selected from metal foils such as Aluminum foil or metal multilayers comprising Aluminum foil and wherein at least 50%, preferably 50-95%, more preferably 50-85%, most preferably 50-75% of the foam surfaces are covered with this gas diffusion tight sealing.

According to preferred embodiments, the gas diffusion tight sealing is a moisture permeable layer, preferably comprising at least an ethylene vinyl alcohol (EVOH) copolymer resin layer as gas barrier polymer.

According to embodiments, the gas diffusion tight sealing may comprise at least one layer of a gas barrier polymer selected from ethylene vinyl alcohol copolymer (EVOH), polyvinyl alcohol (PVOH) and its copolymers, polyvinylidene chloride (PVDC), polyamide (PA), polyethylene terephthalate (PET), Polyketones (PK), Polyacrylonitriles (PAN) and combinations thereof. The gas barrier polymer layer may further comprise one or more additional layers which can, for example, comprise or consist of a thermoplastic polymer such as polyethylene and/or polypropylene. Further suitable sealings for use in the present invention are disclosed in EP 3 000 592.

According to preferred embodiments, the process for making the polyisocyanurate (PIR) comprising insulation foam according to the invention further includes the step of ageing the foam after the step of sealing the foam with a gas diffusion tight sealing. Said ageing step includes keeping the foam at a given temperature above room temperature until a stable low lambda value is obtained indicative of significant reaction between the epoxy compound and CO₂ has taken place. The foam is preferably aged between 25 and 100° C., more preferably between 40 and 80° C., even more preferably between 55 and 70° C., preferably for less than one month, more preferably for less than one week, even more preferably for less than one day.

According to embodiments, the polyisocyanate compounds used in the process for making the polyisocyanurate (PIR) comprising insulation foam according to the invention are selected from organic isocyanates containing a plurality of isocyanate groups including aliphatic isocyanates such as hexamethylene diisocyanate and more preferably aromatic isocyanates such as m- and p-phenylene diisocyanate, tolylene-2,4- and 2,6-diisocyanates, diphenylmethane-4,4′-diisocyanate, chlorophenylene-2,4-diisocyanate, naphthylene-1,5-diisocyanate, diphenylene-4,4′-diisocyanate, 4,4′-diisocyanate-3,3′-dimethyldiphenyl, 3-methyldiphenylmethane-4,4′-diisocyanate and diphenyl ether diisocyanate, cycloaliphatic diisocyanates such as cyclohexane-2,4- and 2,3-diisocyanates, 1-methyl cyclohexyl-2,4- and 2,6-diisocyanates and mixtures thereof and bis-(isocyanatocyclohexyl-)methane and triisocyanates such as 2,4,6-triisocyanatotoluene and 2,4,4′-triisocyanatodiphenyl ether.

According to embodiments, the polyisocyanate composition comprises mixtures of polyisocyanates. For example a mixture of tolylene diisocyanate isomers such as the commercially available mixtures of 2,4- and 2,6- isomers and also the mixture of di- and higher poly-isocyanates produced by phosgenation of aniline/formaldehyde condensates.

Such mixtures are well-known in the art and include the crude phosgenation products containing mixtures of methylene bridged polyphenyl polyisocyanates, including diisocyanate, triisocyanate and higher polyisocyanates together with any phosgenation by-products.

Preferred polyisocyanate compositions of the present invention are those wherein the polyisocyanate is an aromatic diisocyanate or polyisocyanate of higher functionality in particular crude mixtures of methylene bridged polyphenyl polyisocyanates containing diisocyanates, triisocyanate and higher functionality polyisocyanates. Methylene bridged polyphenyl polyisocyanates (e.g. Methylene diphenyl diisocyanate, abbreviated as MDI) are well known in the art and have the generic formula I wherein n is one or more and in the case of the crude mixtures represents an average of more than one. They are prepared by phosgenation of corresponding mixtures of polyamines obtained by condensation of aniline and formaldehyde.

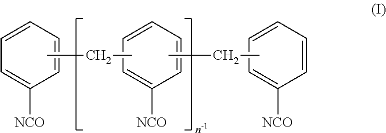

Other suitable polyisocyanate compositions may include isocyanate ended prepolymers made by reaction of an excess of a diisocyanate or higher functionality polyisocyanate with a hydroxyl ended polyester or hydroxyl ended polyether and products obtained by reacting an excess of diisocyanate or higher functionality polyisocyanate with a monomeric polyol or mixture of monomeric polyols such as ethylene glycol, trimethylol propane or butane-diol. One preferred class of isocyanate-ended prepolymers are the isocyanate ended prepolymers of the crude mixtures of methylene bridged polyphenyl polyisocyanates containing diisocyanates, triisocyanates and higher functionality polyisocyanates.

According to embodiments, the polyisocyanate compounds in the polyisocyanate composition are selected from a toluene diisocyanate, a methylene diphenyl diisocyanate or a polyisocyanate composition comprising a methylene diphenyl diisocyanate or a mixture of such polyisocyanates.

According to embodiments, the one or more isocyanate reactive compounds used in the process for making the polyisocyanurate (PIR) comprising insulation foam according to the invention include any of those known in the art for the preparation of said foams. Of particular importance for the preparation of rigid foams are polyols and polyol mixtures having average hydroxyl numbers of from 50 to 1000, especially from 150 to 700 mg KOH/g, and hydroxyl functionalities of from 2 to 8, especially from 3 to 8. Suitable polyols have been fully described in the prior art and include reaction products of alkylene oxides, for example ethylene oxide and/or propylene oxide, with initiators containing from 2 to 8 active hydrogen atoms per molecule. Suitable initiators include: polyols, for example glycerol, trimethylolpropane, triethanolamine, pentaerythritol, sorbitol and sucrose; polyamines, for example ethylene diamine, tolylene diamine (TDA), diaminodiphenylmethane (DADPM) and polymethylene polyphenylene polyamines; and aminoalcohols, for example ethanolamine and diethanolamine; and mixtures of such initiators. Other suitable polymeric polyols include polyesters obtained by the condensation of appropriate proportions of glycols and higher functionality polyols with dicarboxylic or polycarboxylic acids. Still further suitable polymeric polyols include hydroxyl terminated polythioethers, polyamides, polyesteramides, polycarbonates, polyacetals, polyolefins and polysiloxanes.

The quantities of the polyisocyanate compositions and the one or more isocyanate reactive compounds to be reacted will depend upon the nature of the polyisocyanurate (PIR) comprising insulation foam to be produced and can be readily determined by those skilled in the art.

According to preferred embodiments, the physical blowing agent with a lambda gas ≤12 mW/m·K at 10° C. is selected from at least HFO blowing agents and/or HCFO blowing agents and/or hydrocarbons such as cyclo-pentane having a a lambda gas value ≤12 mW/m·K at 10° C.

According to preferred embodiments, the physical blowing agent with a lambda gas ≤12 mW/m·K at 10° C. comprises at least HFO blowing agents and/or HCFO blowing agents and/or hydrocarbon such as cyclo-pentane having a a lambda gas value ≤12 mW/m·K at 10° C.

According to embodiments, the physical blowing agent with a lambda gas <12 mW/m·K at 10° C. comprise at least 3,3,3-trifluoropropene, 1,2,3,3,3 -pentafluoropropene, cis- and/or trans-1,3,3,3-tetrafluoropropene and/or 2,3,3,3-tetrafluoropropene, and/or 1,1,1,4,4,4-hexafluorobut-2-ene, and/or 1-chloro-3,3,3-trifluoropropene, and/or 2-chloro-3,3,3-trifluoropropene and mixtures thereof.

Preferred examples of commercially available suitable HFO blowing gases are Honeywell HFO-1234ze (Honeywell's trade name for trans-1,3,3,3-tetrafluoropropene) or Opteon® 1100 (Chemours' trade name for cis-1,1,1,4,4,4-hexafluorobut-2-ene, CF₃CH═CHCF₃).

A preferred example of a commercially available suitable HCFO blowing gas is Honeywell Solstice® LBA 1233zd (Honeywell's trade name for trans- 1 -chloro-3,3,3-trifluoropropene, CHCl═CHCF₃) or Forane® 1233zd (Arkema's trade name for trans-1-chloro-3,3,3-trifluoropropene, CHCl═CHCF₃).

According to embodiments, the reactive composition may further comprise blowing agents having a lambda gas value ≤12 mW/m·K at 10° C. selected from hydrofluorocarbons (HFCs) and/or hydrocarbons such as cyclo-pentane and mixtures thereof.

According to embodiments, the reactive composition may further comprise additional blowing agents such as hydrocarbons selected from iso-pentane, iso-butane, n-pentane and mixtures thereof having a lambda gas value >12 mW/m·K at 10° C.

According to embodiments, the reactive composition may further comprise additional blowing agents selected from formic acid, methylformate, dimethyl ether, water, methylene chloride, acetone, t-butanol, argon, krypton, xenon and mixtures thereof.

The amount of blowing agent used can vary based on, for example, the intended use and application of the foam product and the desired foam properties and density. The blowing agent may be present in amounts from 1 to 60 parts by weight (pbw) per hundred parts by weight isocyanate reactive compounds (polyol), more preferably from 2 to 45 pbw. If (optionally) water is used as one of the blowing agents in the foam formulation, the amount of water is preferably limited to amounts up to 15 pbw, preferably <5 pbw, more preferably <3 pbw.

According to embodiments, the at least one blowing agent having a lambda gas value ≤12 mW/m·K at 10° C., may comprise additional blowing agents having a lambda gas value >12 mW/m·K at 10° C. and the ratio of blowing agent having a lambda gas value ≤12 mW/m·K at 10° C. to the additional blowing agents is in the weight ratio 95/5 up to 5/95 calculated on the total weight of all blowing agents.

According to embodiments, the physical blowing agent with a lambda gas ≤12 mW/m·K at 10° C. is selected from HCFO and/or HFO blowing agents and comprises cyclopentane or mixtures of cyclopentane and isopentane as additional blowing agent and the ratio of HCFO and/or HFO blowing agents to cyclopentane blowing agent is in the weight ratio 95/5 up to 5/95 calculated on the total weight of all blowing agents.

There are many different orders of contacting or combining the compounds of the reactive composition required to make the PIR comprising foam of the present invention. One of skilled in the art would realize that varying the order of addition of the compounds falls within the scope of the present invention.

According to embodiments, the combining and mixing of the CO₂ scavenging compound(s) may be performed by adding said CO₂ scavenging compound(s) to the isocyanate-reactive composition before combining and/or mixing with the polyisocyanate composition (in other words the CO₂ scavenging compound(s) is added to the polyisocyanate-reactive composition before it is allowed to react with the polyisocyanate composition).

According to embodiments, the combining and mixing of the CO₂ scavenging compound(s) may be performed by adding said CO₂ scavenging compound(s) to the polyisocyanate composition before combining and/or mixing with the isocyanate-reactive composition (in other words the CO₂ scavenging compound(s) is added to the polyisocyanate composition before it is allowed to react with the polyisocyanate-reactive composition).

According to embodiments, the combining and mixing of the CO₂ scavenging compound(s) may be performed by adding said CO₂ scavenging compound(s) after lay-down of the reactive composition, said reactive composition being created by combining and/or mixing the polyisocyanate composition, the isocyanate-reactive composition, the catalyst compound(s), blowing agent(s) and optionally other ingredients.

According to embodiments, the combining and mixing of the CO₂ scavenging compound(s) may be performed by adding said CO₂ scavenging compound(s) to the reactive composition already being present in a mould, said reactive composition being created by combining and/or mixing the polyisocyanate composition, the isocyanate-reactive composition, the catalyst compound(s), blowing agent(s) and optionally other ingredients.

According to embodiments, the combining and mixing of the CO₂ scavenging compound(s) may be performed by adding said CO₂ scavenging compound(s) to the mould before injecting the reactive composition in the mould, said reactive composition being created by combining and/or mixing the polyisocyanate composition, the isocyanate-reactive composition, the catalyst compound(s), blowing agent(s) and optionally other ingredients.

According to a third aspect, a polyisocyanurate (PIR) comprising insulation foam having significantly improved thermal insulation properties maintained over the average economic lifetime of the foam is disclosed and made by the process according to the second aspect of the invention and making use of the reactive composition of the first aspect of the invention.

According to embodiments, the PIR comprising foam according to the invention has preferably an amount of residual scavenging compound in the stabilized aged foam between 0 and 10 wt %, more preferably between 0 and 5 wt %, even more preferably between 0 and 3 wt % calculated on the total weight of the stabilized aged foam.

According to embodiments, the PIR comprising insulation foam of the invention has a stabilized aged lambda value which is at least 1 mW/m·K at 10° C. lower compared to state of the art polyisocyanurate (PIR) insulation foams using equal amounts and type of blowing agents but without using CO₂ scavengers after the same period of time.

According to embodiments, the wt % of CO₂ in the stabilized aged foam is between 0 and 2 wt %, preferably between 0 and 1 wt %, more preferably between 0 and 0.5 wt %, calculated on the total weight of the stabilized aged foam.

According to embodiments, the amount of residual epoxy compound in the stabilized aged foam is between 0 and 10 wt %, more preferably between 0 and 5 wt %, even more preferably between 0 and 3 wt % calculated on the total weight of the stabilized aged foam.

According to embodiments, the polyisocyanurate (PIR) comprising insulation foam according to the invention is kept under air diffusion tight conditions with a gas diffusion tight sealing and at least 50%, at least 75%, preferably at least 90%, more preferably 95%, most preferably 90-100% of the foam surfaces are covered with the gas diffusion tight sealing.

According to preferred embodiments, the gas diffusion tight sealing is a moisture permeable layer, preferably comprising at least an ethylene vinyl alcohol (EVOH) copolymer resin layer as gas barrier polymer.

According to embodiments, the gas diffusion tight sealing may comprise at least one layer of a gas barrier polymer selected from ethylene vinyl alcohol copolymer (EVOH), polyvinyl alcohol (PVOH) and its copolymers, polyvinylidene chloride (PVDC), polyamide (PA), polyethylene terephthalate (PET), Polyketones (PK), Polyacrylonitriles (PAN) and combinations thereof. The gas barrier polymer layer may further comprise one or more additional layers which can, for example, comprise or consist of a thermoplastic polymer such as polyethylene and/or polypropylene. Further suitable sealings for use in the present invention are disclosed in EP 3 000 592.

According to embodiments, the polyisocyanurate (PIR) comprising insulation foam according to the invention is kept under air diffusion tight conditions and the gas diffusion tight sealing is selected from metal foils such as Aluminum foil or metal multilayers comprising Aluminum foil and wherein at least 50%, preferably 50-95%, more preferably 50-85%, most preferably 50-75% of the foam surfaces are covered with the gas diffusion tight sealing.

The PIR comprising insulation foams according to the invention will give rise (after a stabilizing period wherein the scavenger is capturing the CO₂) to insulation foams having significantly low thermal conductivity. Said polyisocyanurate (PIR) comprising insulation foams may have a stabilized aged thermal conductivity over time which is lower than the initial thermal conductivity immediately after production of the foam due to the consumption of CO₂ by the CO₂ scavenger, the use of blowing agents having a a lambda gas value ≤12 mW/m·K at 10° C. such as HFO/HCFO comprising blowing agents and the diffusion tight conditions.

According to embodiments, the polyisocyanurate (PIR) comprising insulation foam according to the invention is a rigid insulation foam.

According to embodiments, the polyisocyanurate (PIR) comprising insulation foam according to the invention has a foam density <45 kg/m³ and a stabilized thermal conductivity <20 mW/m·K at 10° C., preferably 14 up to 20 mW/m·K at 10° C.

According to embodiments, the polyisocyanurate (PIR) comprising insulation foam according to the invention has a foam density >45 kg/m³ and a stabilized thermal conductivity <25 mW/m·K at 10° C., preferably 14 up to 25 mW/m·K at 10° C.

According to embodiments, the polyisocyanurate (PIR) comprising insulation foam according to the invention has a closed cell content higher than 70% calculated on the total amount of closed and open cells being present in the material.

According to embodiments, the PIR comprising foam of the instant invention may be used as thermal insulator such as construction thermal insulation foam, appliance thermal insulation foam or pipe insulation. The polyisocyanurate (PIR) comprising insulation foam of the instant invention fulfills all the requirements for use as insulation material especially due to its low thermal conductivity value.

### FIGURES

FIG. 1 illustrates the influence of the CO₂ scavenger on the lambda value (measured at 10° C.) in function of time (ageing at room temperature) for foams made according to the invention (examples 1 & 2) and for comparative foams (comparative examples 1 & 2).

### EXAMPLES

Chemicals Used:
Polyol: aromatic polyester polyol with OHv=240 mg KOH/g (Stepanpol® PS 2352 from Stepan)
Flame retardant Tris (chloroisopropyl) phosphate (TCPP)
Catalyst 1: Pentamethyldiethylenetriamine (PMDETA)
Catalyst 2 : Potassium octoate based catalyst (Dabco® K15)
Catalyst 3 : Potassium acetate based catalyst (LB catalyst)
Catalyst 4 : Tetrabutylammonium bromide (TBAB, Sigma-Aldrich)
Foam stabilizer: Silicon surfactant (Tegostab® 8494 from Evonik)
Blowing agent: Cyclopentane (CP, Alfa-Aesar)
Water
Epoxy compound: Phenyl Glycidyl Ether (PGE, Sigma-Aldrich)
Polyisocyanate Suprasec® 2085 (S2085 from Huntsman), a high functionality polymeric MDI composition having NCO%=30.5 and an average functionality=2.9

Fabrication of PIR comprising insulation foams using CO₂ scavenger and Cyclopentane blowing agent (examples 1 & 2) and comparative examples 1&2 using no or limited amount of CO₂ scavenger (illustrating the effect of the CO₂ scavenger)

The following PIR formulations (Table 1) were foamed in a closed metallic mold (20×20×4 cm³) pre-heated to 50° C. of which internal surfaces were preliminarily covered with a gas diffusion tight sealing (a multilayer Aluminum comprising foil being impermeable to Air). Demolding was performed after lh and the sealing was removed from the lateral foam sides leaving them open. The resulting foams therefore had their top and bottom surfaces covered with a gas diffusion tight sealing (71.4% of the surfaces of the foams).

For the foams containing the epoxy compound (PGE), the CO_{2/}epoxy reaction catalyst (TBAB) was first dissolved inside the epoxy compound before mixing the resulting solution with the rest of the polyol blend prior reaction with the isocyanate, and the weight ratio TBAB/PGE was kept constant at 0.33.

The amount of reaction mixture inserted inside the mold was adjusted to ensure good mold filling as well as minimal overpacking. The foams were aged at room temperature and their lambda value at 10° C. was measured in a LaserComp Fox200 at regular time intervals until reaching a constant value (stabilized lambda value, ˜100 days). CO₂ levels inside the foams were then determined by cell gas analysis (internally developed method). FTIR (Fourier Transform InfraRed) spectra were also recorded to qualitatively evidence or not the presence of carbonate adducts in the foams (wavenumber ˜1798 cm⁻¹).

TABLE 1
Rigid PIR foam formulations

| | Comp. | Comp. | | |
|---|---|---|---|---|
| | Ex. 1 | Ex. 2 | Example 1 | Example 2 |
| Chemicals | (pbw) | (pbw) | (pbw) | (pbw) |
| PS2352 | 80.16 | 80.16 | 80.16 | 80.16 |
| TCPP | 16 | 16 | 16 | 16 |
| PMDETA | 0.1 | 0.1 | 0.1 | 0.1 |
| K15 | 1.36 | 1.36 | 1.36 | 1.36 |
| LB | 0.45 | 0.45 | 0.45 | 0.45 |
| TBAB | 0 | 1.39 | 7.16 | 16.21 |
| TB8494 | 1.6 | 1.6 | 1.6 | 1.6 |
| CP | 17.2 | 17.2 | 17.2 | 17.2 |
| Water | 0.33 | 0.33 | 0.33 | 0.33 |
| PGE | 0 | 4.17 | 21.48 | 48.63 |
| Total polyol | 117.2 | 122.76 | 145.84 | 182.04 |
| blend | | | | |
| Suprasec ® 2085 | 170 | 170 | 170 | 170 |
| Iso Index | 314 | 314 | 314 | 314 |
| Foam density | 53 | 53 | 59 | 76 |
| (kg/m³) | | | | |
| Molar ratio | 0 | 1.5 | 7.8 | 17.7 |
| PGE/water | | | | |

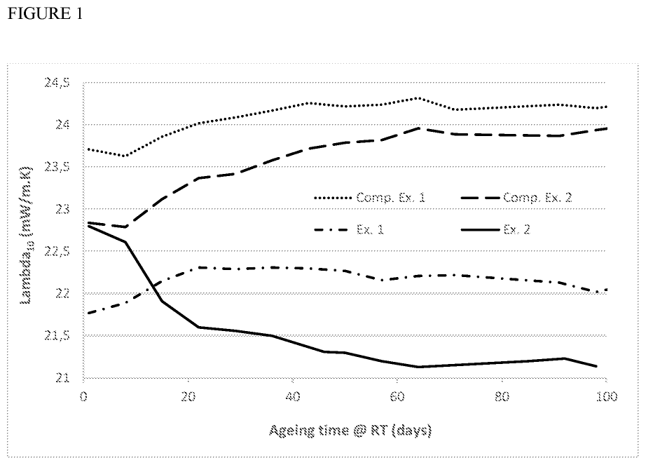

The lambda values for the 4 foams are plotted in FIG. 1 and additional foam properties are summarized in Table 2. Comparative Example 1 which is free of CO₂ scavenger epoxy compound has the highest aged lambda value and the largest amount of CO_{2.} Comparative Example 2 which comprises a small amount of epoxy compound in its formulation displays only a negligible decrease in its aged lambda value compared to the epoxy compound-free Comparative Example 1, together with a significant level of residual CO_{2.} Examples 1 and 2 according to the invention have higher amounts of epoxy compounds and ultimately display lower aged lambda values and significantly lower levels of CO₂ compared to Comparative Examples 1 and 2, indicative of successful CO₂ scavenging. Carbonate group formation was confirmed as well by the well noticeable presence of FTIR absorption peaks at 1798 cm⁻¹.

These results evidence that the proper amount of epoxy compound is crucial to significantly scavenge CO₂ and to ultimately achieve improved thermal insulation performance (i.e. lower lambda values), and as a consequence epoxy group/water molar ratios larger than 7.8 have to be used (or in other words the molar amount of epoxy compounds in the reactive composition needs to be at least 7.8 times higher than the molar amount of CO₂ formed by the water).

TABLE 2
PIR foam properties

| | | | | | | | FTIR |
|---|---|---|---|---|---|---|---|
| | Molar ratio | | | | | | carbonate |
| | epoxy | PGE amount | | Lambda | Lambda | Delta | signal |
| | group/water | in starting | CO₂ amount | (10° C.) fresh | (10° C.) aged | lambda | intensity at |
| | in starting | formulation | in aged | foams | foams | (10° C., | 1798 cm⁻¹ |
| | formulation | (wt %) | foams (wt %) | (mW/m · K) | (mW/m · K) | aged-fresh) | (aged foams) |
| Comp. | 0 | 0 | 2.38 | 23.7 | 24.3 | +0.6 | No Peak |
| Ex. 1 | | | | | | | |
| Comp. | 1.5 | 1.4 | 1.67 | 22.8 | 24.0 | +1.2 | Very Small |
| Ex. 2 | | | | | | | |
| Ex. 1 | 7.8 | 6.8 | 0.53 | 21.8 | 22.1 | +0.3 | Small |
| Ex. 2 | 17.7 | 13.8 | 0.05 | 22.8 | 21.1 | −1.7 | Medium |

1. A composition for making a PIR comprising foam at an isocyanate index of at least 120, wherein said composition comprises:
a) An isocyanate composition comprising one or more isocyanate compounds, and
b) An isocyanate-reactive composition comprising one or more isocyanate-reactive compounds, and
c) At least one PIR promoting catalyst, and
d) At least one physical blowing agent with a lambda gas ≤12 mW/m·K at 10° C., and
e) At least one CO₂ scavenging compound selected from at least one epoxy compound having an equivalent weight lower than 300 g/mol, and
f) Optionally a catalyst promoting epoxy reaction with CO₂
Characterized in that the amount of isocyanate-reactive compounds in the reactive composition is at least 10 wt % calculated on the total weight of the reactive composition and the molar amount of epoxy compounds in the reactive composition is at least 7.8 times higher than the molar amount of CO₂ formed by the water present in the reactive composition after reaction with isocyanates.

2. The reactive composition according to claim 1 wherein the amount of isocyanate-reactive compounds in the reactive composition is at least 10 wt % calculated on the total weight of the reactive composition.

3. The reactive composition according to claim 1 wherein the molar amount of epoxy compounds in the reactive composition is at least 10 times higher than the molar amount of CO₂ formed by the water present in the reactive composition after reaction with isocyanates.

4. The reactive composition according to claim 1 wherein the maximum amount of all the epoxy compounds in the reactive composition is <25 wt %, calculated on the total weight of the reactive composition.

5. The reactive composition according to claim 1 wherein the at least one epoxy compound is selected from epoxy compounds having equivalent weight lower than 300 g/mol and wherein the at least one epoxy compound used is liquid at 20° C.

6. The reactive composition according to claim 1 wherein the catalyst used for promoting epoxy reaction with CO₂ is selected from ammonium salts.

7. The reactive composition according to claim 1 wherein the at least one physical blowing agent having a lambda gas value ≤12 mW/m·K@10° C. is selected from an HFO blowing agent, an HCFO blowing agent, a hydrocarbon, and mixtures thereof

8. The reactive composition according to claim 1 wherein the at least one physical blowing agent having a lambda gas value ≤12 mW/m·K@10° C. is selected from chlorofluorocarbons (CFCs), hydrofluorocarbons (HFCs) and hydrochlorofluorocarbons (HCFCs), and mixtures thereof.

9. The reactive composition according to claim 1 wherein the polyisocyanate compounds are selected from a toluene diisocyanate, a methylene diphenyl diisocyanate, a polyisocyanate composition comprising a methylene diphenyl diisocyanate, or a mixture of such polyisocyanates.

10. The reactive composition according to claim 1 wherein the one or more isocyanate reactive compounds comprise polyols and polyol mixtures having average hydroxyl numbers of from 50 to 1000 and hydroxyl functionalities of from 2 to 8.

11. The reactive composition according to claim 1 wherein the blowing agent is present in an amount of 1 to 60 parts by weight per hundred parts by weight isocyanate reactive compounds.

12. The reactive composition according to claim 1 further comprising beside the blowing agents having a lambda gas value ≤12 mW/m·K at 10° C. additional blowing agents having a lambda gas value >12 mW/m·K at 10° C. and wherein the ratio of blowing agents having a lambda gas value ≤12 mW/m·K at 10° C. to the additional blowing agents is in the weight ratio 95/5 up to 5/95 calculated on the total weight of all blowing agents.

13. A process for making a PIR comprising insulation foam, said process comprising combining and/or mixing the ingredients of the reactive composition according to claim 1 at an isocyanate index of at least 120, preferably at least 150, more preferably at least 200, most preferably at least 250.

14. The process according to claim 13 further including a step of sealing the foam with a gas diffusion tight sealing wherein at least 50% of the foam surfaces are covered with the gas diffusion tight sealing.

15. The process according to claim 13 wherein the gas diffusion tight sealing is selected from metal foils, gas barrier polymer layers, a thermoplastic polymer, and combinations thereof.

16. The process according to claim 13 further including after sealing the foam a step of ageing the foam, said ageing step includes keeping the foam at a given temperature above room temperature until a stable low lambda value is obtained.

17. A stabilized PIR comprising insulation foam made using the process according to claim 13 wherein the wt % of CO₂ in the stabilized aged foam is between 0 and 2 wt %, calculated on the total weight of the stabilized aged foam.

18. The stabilized PIR comprising insulation foam according to claim 17 having a foam density <45 kg/m³ and a stabilized thermal conductivity <20 mW/m·K at 10° C.

19. The stabilized PIR comprising insulation foam according to claim 17 having a foam density >45 kg/m³ and a stabilized thermal conductivity <25 mW/m·K at 10° C.

20. A thermal insulator comprising the polyisocyanurate (PIR) comprising insulation foam according to claim 17.
